(19) United States
(12) Patent Application Publication
(10) Pub. No.: US 2005/0204103 A1
(43) Pub. Date: Sep. 15, 2005

(54) Split queuing

(75) Inventor: Larry R. Dennison, Walpole, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avici Systems, Inc., N. Billerica, MA (US)

(21) Appl. No.: 11/070,866

(22) Filed: Mar. 1, 2005

Related U.S. Application Data
(60) Provisional application No. 60/549,090, filed on Mar. 1, 2004.

(51) Int. Cl. G06F 12/00

(52) U.S. Cl. 711/154

(57) ABSTRACT

Queuing operations are separated into distinct logical blocks despite the need to share information. Preparatory operations such as queue status fetching, correctness check and random early drop operation may be performed in one or more logical blocks and the completion of the queuing operation, either enqueuing, dequeuing or both, may be performed in another logical block. The operations processed in the first logical block may pass information to the operations processed in the second logical block to improve sharing of information.

### RELATED APPLICATIONS

This application is a continuation-in-part of U.S. Application entitled “Split Queuing” filed Feb. 28, 2005 under Attorney Docket No. 2390.2014-001 which claims the benefit of U.S. Provisional Application No. 60/549,090, filed on Mar. 1, 2004. The entire teachings of the above applications are incorporated herein by reference.

### BACKGROUND OF THE INVENTION

Queuing system control logic is generally implemented in a single logical block that supports enqueue and dequeue operations. Since enqueue and dequeue operations use much of the same state, it is convenient to use a single logical block to implement both operations. When servicing an enqueue operation, the appropriate queue is determined, the queue information is read, the correctness of the enqueue operation is determined (e.g., is there space, am I allowed to enqueue, etc?), the data is written and the queue information is updated. Likewise, when servicing a dequeue operation, the appropriate queue information is read, the correctness of the dequeue operation is determined (e.g., is there something to dequeue?), the data is dequeued and the queue information is updated.

An example of a single queue implemented as a circular buffer in memory is shown in FIG. 1. For each queue, there is a head index, a tail index and a queue size. This and other control state associated with a specific queue, such as the base pointer of the queue data, is called that queue's queue state. Obviously, there are other possible implementations.

The first of the three states shown in FIG. 1 shows the original condition of the queuing system. There are eight elements already enqueued. The head index is pointing to the head value in the queue at location 1. The tail index is pointing to the first empty location at the end of the queue. Thus, this queuing system cannot completely fill the circular buffer. The capacity of the queue is one less than the size of the data array. In this example the maximum number of elements within the queue is 15 while the size of the data array is 16.

One way to perform an enqueue operation in this example infrastructure first requires reading the queue state that consists of the head and tail indexs as well as the size of the queue. Queue state is often kept in external memory. Keeping queue state in external memory enables a large number of queues; there would not be enough registers to support thousands of queues. It is possible to cache frequently used queue state in closer, faster memory, but care must be taken to not assume cache hits when predicting performance. Such a queuing system, with queue state in external memory 20, is shown in FIG. 2. A four-entry queue state cache 22 is shown within the Queue Engine 24. Queue state is read from memory and stored within the cache where it can be quickly accessed.

Once the head index, tail index and size are available, a correctness check can be performed. The tail index is incremented modulo the size and compared to the head index. If the head index and tail index are equal, then the queue would overflow if the enqueue operation was performed and thus appropriate action is taken to avoid that error. However, if the head index and tail index are not equal, the enqueue operation will not overflow the queue and thus it is legal to perform the enqueue operation.

In addition to a queue correctness check, there may be additional criteria that must be satisfied before completing a enqueue operation. For example, there is a mechanism called random early drop (RED) that probabilistically forces packets to be dropped before they can even be enqueued. For RED, the probability of early drop is dependent on the depth of the queue in bytes. Thus, even though there may be space in the queue to enqueue another packet, there may be other reasons why that packet should not be enqueued.

Once it has been determined that the packet can be enqueued and should be enqueued, the enqueue operation is completed by writing the value into the data array and writing back the new tail index as illustrated in the second state of FIG. 1.

If a dequeue operation is performed, the head index and the tail index are read. If the head index and tail index are equal to each other, the queue is empty and thus a dequeue operation would be illegal and appropriate action must be taken. If the dequeue operation is, however, legal, the value in the data array at the head position is read, the head index is incremented modulo the queue size and written back and the value returned as the result of the dequeue operation as illustrated in the third state of FIG. 1.

Note that both of these operations are fairly costly in terms of operations, especially long latency memory load operations. In this example configuration, a successful enqueue requires at least three reads (that can potentially be combined into a single block read) and at least two writes (that probably cannot be combined into a single block write.) Any additional functionality like RED will require likely require additional memory operations. In this example configuration, a successful dequeue requires at least four reads (three of which can potentially be combined into a single block read) and a single write. Three of the reads for an enqueue and two of the reads for a dequeue must complete to determine if the operation is successful. In certain systems, such as a software-based network processor, performing all of the necessary operations takes a prohibitively long time and can negatively impact performance to the point where the desired performance cannot be achieved.

There are other queue engines based on linked lists rather than arrays. In those systems, at least a head pointer and a tail pointer must be maintained for each queue. Unlike in the array-based scheme, the head and tail pointers actually point to locations in memory. An example of performing an enqueue operation and a dequeue operation in a linked list system is shown in FIGS. 3 A-D. Obviously, there are other possible implementations of a linked-list queue.

In this example of a linked-list queue, there are three elements enqueued at time Start in FIG. 3A. The head pointer 32 points to an element storage block 26 (also called storage block for short) that contains Element 1. The storage block containing Element 1 also has a next pointer 34 that points to a storage block 28 containing Element 2. Element 2's storage block 28 points to Element 3. Element 3's storage block 30 points to nothing (generally indicated by a NULL pointer.) The tail pointer 36 points to the last element. In addition to the head and tail pointers, a count 38 indicating the number of elements enqueued is often maintained for each queue. Like the array-based queues, the head and tail pointers along with the count and any other state specific to the queue control are called the queue state.

To enqueue in a linked-list queue, first the queue pointers must be read from memory. To maximize the number of possible queues, linked-list based queues, like array-based queues, keep queue state in memory and thus the queue state must be read from memory (or cached locally and read from the cache) before the operation can start. Once the queue state is available, the count can be used to determine whether to allow the element to be enqueued. Additional information, such as the number of available element storage blocks or additional parameters associated with the queue may also be necessary to determine whether to allow the element to be enqueued. Once the decision has been made to enqueue the element, an element storage block, 40 in FIG. 3B, is allocated, the element is written to the storage block, the tail pointer is followed to the current last storage block, that storage block's next pointer is changed from NULL to the newly allocated storage block as illustrated in FIG. 3C. The newly allocated storage block's next pointer is set to NULL and the tail pointer is set to point to the newly allocated storage block.

To dequeue from a linked-list queue, the queue state must first be obtained and a determination of whether the dequeue is correct is made, if desired. (It is possible that the code is trusted enough that dequeues do not need a correctness check.) Once it has been decided to go ahead with the dequeue, the head pointer is used to find the storage block containing the element at the head of the queue. That element is read from the storage block along with the next pointer that is then set to be the new value of the head pointer as illustrated in FIG. 3D. The just-read storage block 26 is deallocated.

There are some systems, such as some network processors, that provide special-purpose queuing hardware that implement the underlying queuing structures and allow software to perform “enqueue” and “dequeue” operations without manually updating the head and tail pointers and next pointers within the element storage blocks. For such network processors, it is often the case that a limited number of queues can be supported by such hardware-assisted queuing structures and software is required to manage those limited numbers of queues. The Intel IXP2400 and IXP2800 products provide such hardware that support both linked list and array-based queues. The hardware supports the following types of commands

```
read/write all of the queue state for a particular queue from/to memory
once a queue's queue state is in the cache
    read/write fields in the queue state (can read the size of the queue)
    enqueue storage blocks to the end of the linked list/array queue
    dequeue storage blocks from the head of the linked list/array queue
```

A block diagram of how queuing might be implemented on an Intel IXP2400 network processor consisting of at least six logical blocks is shown in FIG. 4. In this case, each of the logical blocks maps to a hardware micro-engine 42 within the network processor, the engines 42b, c, d and e each supporting OC-12 queuing. Since a single micro-engine implements the entire egress queuing system, including queue state fetch, correctness check, RED, enqueue and dequeue, for a particular OC-12 interface, it does not contend for the same queues with the other micro-engines. Existing implementations of queuing systems on the IXP2400, however, are not capable of performance much higher than OC-12. Thus, though the IXP2400 is capable of supporting a half-duplex OC-48's worth of bandwidth, it was not capable of supporting a single OC-48c interface because the available queuing system code was only capable of an OC-12 interface worth of bandwidth.

### SUMMARY OF THE INVENTION

The time required to perform an entire enqueue operation or dequeue operation is prohibitive in some systems given certain performance requirements. Such a system might include a network processor running in an Internet core application. Rather than performing the entire enqueue or dequeue operation in a single logical block, such as a single micro-engine within a network processor, this invention separates enqueue operations and dequeue operations into multiple logical blocks. Since each block performs only part of the operation, each block has less work to do than a single block performing the entire operation, thus increasing overall performance.

This splitting of queuing operations into multiple blocks was one of the techniques used to implement a single OC-48c interface's egress processing on a single IXP2400.

In general, a method of queuing comprises performing the queuing operation across multiple logical blocks, each logical block being limited to an independent thread of control. More specifically, a portion of a queuing operation is performed in a first logical block and another portion of the queuing operation is performed in a second logical block.

The separate logical blocks may, for example, be defined by separate processing hardware, such as micro-engines in a network processor.

The queuing operations may be distributed across additional logical blocks. For example, an enqueuing completion operation may be included in one logical block and a dequeuing completion operation may be included in another logical block. Preparatory operations such as fetching of queue state, correctness check and a random early drop operation are advantageously processed in the first logical block, but select ones may be processed in the second logical block.

Though queuing operations have typically been processed in a common logical block to facilitate sharing of information such as head and tail pointers, the bandwidth advantage of processing queuing operations in separate logical blocks can offset the disadvantages of less efficient access to shared information. To improve upon the sharing of information, the portion of the queuing operation in the first logical block may pass information on to the portion processed in the second logical block. For example, the information may be a pointer to where in memory a value is to be written or read. Information may also include a number of remaining entries within the queue.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a ray based queuing and control.

FIG. 2 illustrates memory based queue state.

FIGS. 3A-D illustrate linked list based queuing.

FIG. 4 illustrates queuing in a micro-engine based network processor.

FIG. 5 illustrates implementation of the present invention on a network processor with at least six micro-engines.

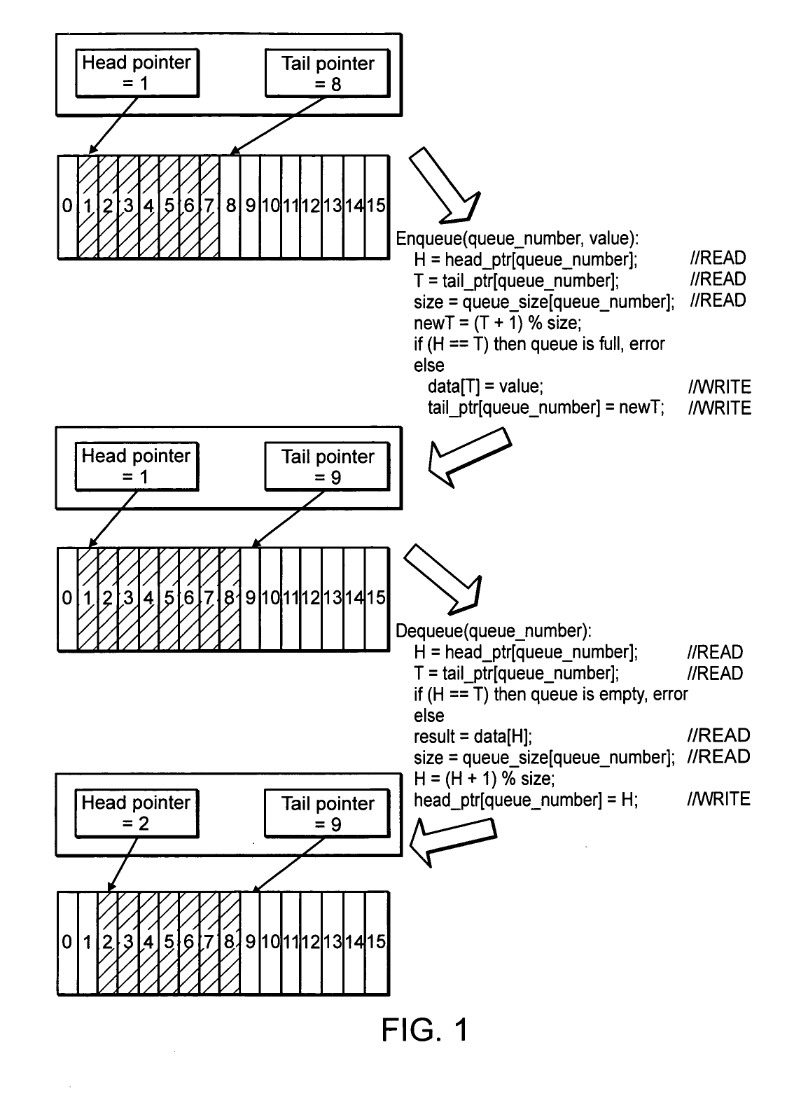

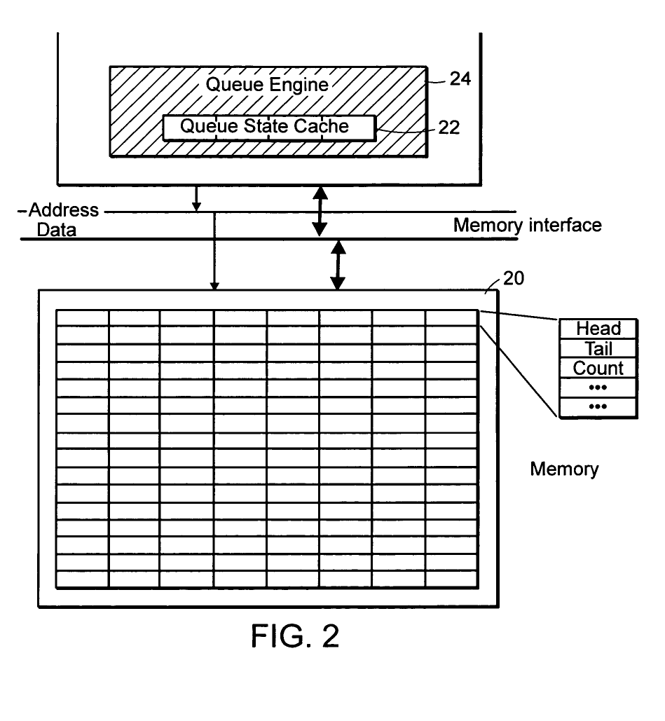

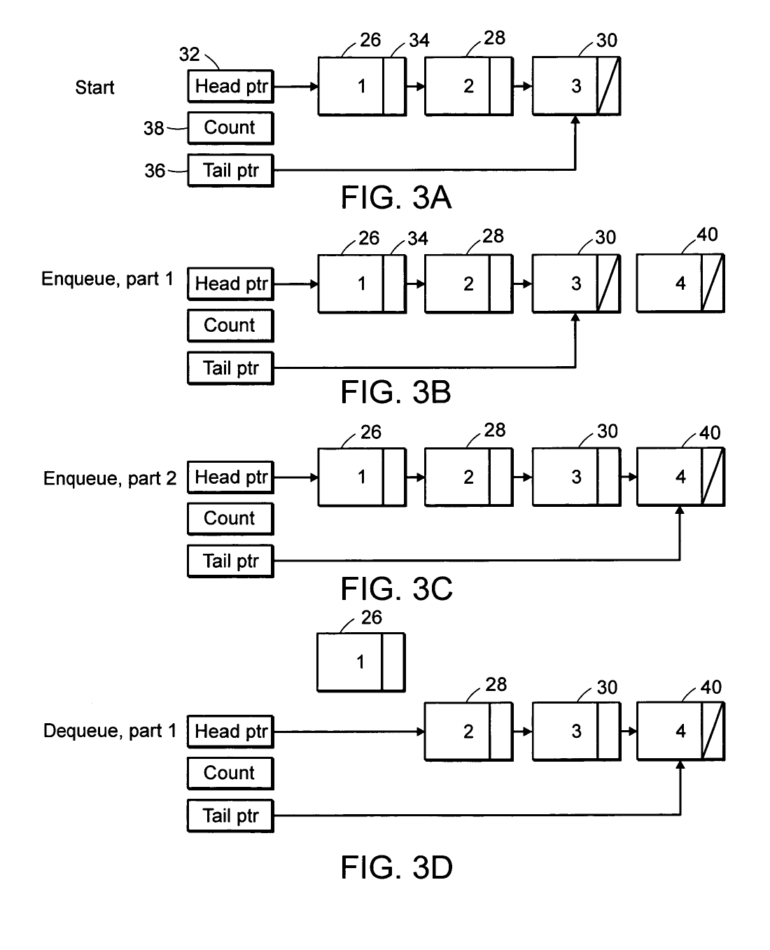

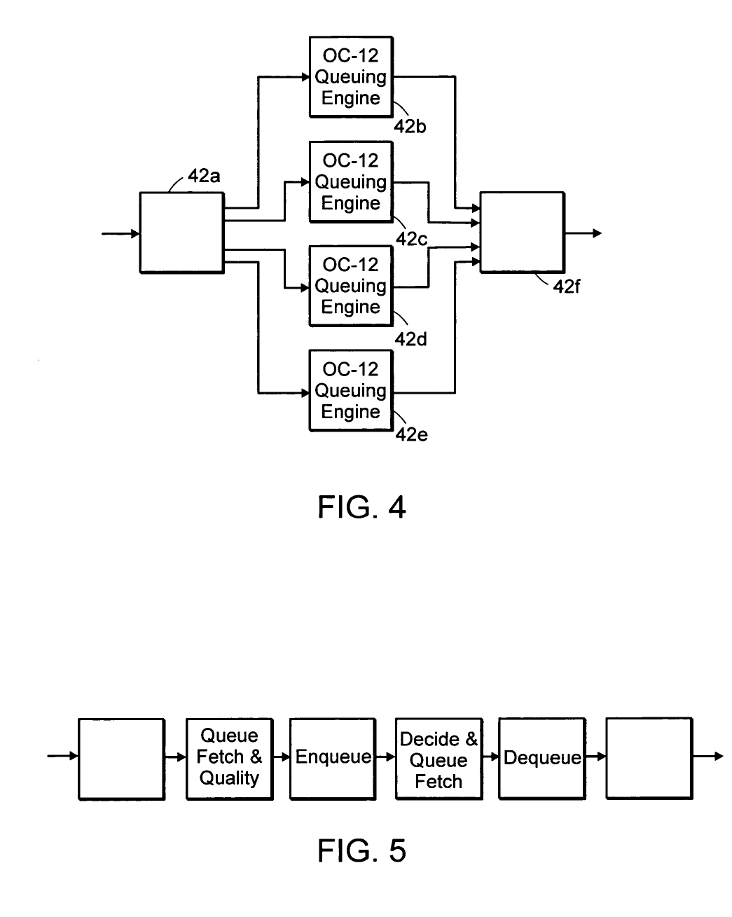

### DETAILED DESCRIPTION OF THE INVENTION

A description of preferred embodiments of the invention follows.

Queuing systems are found everywhere, from computing systems to networking systems to checkout lines at the supermarket. One place where queues are extensively used are inside of switches or routers. If there are more packets that want to use a resource than that resource can handle, some systems will queue those packets until the resource is able to handle them or until the packets need to be dropped for some reason. To avoid one slow or blocked resource blocking packets that do not depend on it, queuing systems will often have separate queues that can be individually enabled or blocked. By mapping independent resource sets to different queues, blocking one resource set and thus its set of queues will not block the other queues destined to other resource sets. Even within a single resource set, there may be multiple queues representing different priorities. Thus, in a standard queuing system, there may be many tens of thousands of queues or more.

High performance queuing systems found in high performance systems such as routers are often implemented in special-purpose hardware to meet their performance requirements. In such systems, it is often the case that a single logical block that contains all of the queue state performs the entire enqueue and dequeue operations. The queue state needed by both enqueue operations and dequeue operations is the same and thus keeping a single copy of that state and implementing both operations around that single copy of the state is the obvious implementation. In these dedicated hardware cases, a sufficient number of resources are provided to support any combination of queuing operations. The required resources could include fast memories for queue state, additional contexts to tolerate long latencies to memory, combining buffers and bypasses that ensure multiple requests to the same queue are processed using the same access to the queue state and so on.

Such hardware systems, however, are difficult and expensive to develop. In addition, those that are hard-wired into an ASIC are inflexible. Recently, there has been a trend towards programmable devices, such as the Intel IXP network processors, that support such queuing systems in software, potentially with some hardware assist. In such devices, microcode runs on a set of small microprocessors to support almost arbitrary functionality ranging from packet classification and forwarding to queuing. Such microcode is extremely difficult to write, since it must carefully manage a very restricted set of resources across several simultaneously executing threads. In addition, since such programmable devices must be general, they may not always have sufficient resources to support full-performance queuing within a single logical block. More hardware-based implementations may have similar constraints for a variety of reasons. Thus, having the ability to split a queuing system into two parts has potential application in any queuing system.

Rather than implementing the queuing operations within a single logical block, this invention describes how to split the implementation across multiple logical blocks. This split reduces the amount of work in each logical block, thus potentially making the amount of work mappable to a physical resource, such as a micro-engine, that was not capable of supporting the entire queuing operation at the desired performance.

Note that it may be the case that the split duplicates some work and thus it may actually be less efficient than implementing the entire functionality in a single logical block. Even in such cases, however, it is still worthwhile to perform the split if the desired functionality and performance cannot otherwise be achieved.

Enqueue and dequeue operations both generally require access to queue state to determine if the operation is correct and should be performed before the operation can be completed. In some systems, it is necessary or convenient to complete the check before the actual enqueue or dequeue is performed to ensure correctness. In addition, there may be additional work required that logically fits between performing the check and performing the enqueue or dequeue. In such cases, being able to split the total enqueue/dequeue operations into multiple parts can be very useful. Thus, this invention is particularly useful for such systems.

An example of this invention breaks the original single logical block into two blocks, Block_{A} and Block_{B}, that implement the queuing functionality. Block_{A} qualifies the operation, ensuring that the operation has the resources available to complete and is allowed to complete before passing the operation to Block_{B} that performs the operation. Both blocks have their own copies of the queue information, though they may not be precisely coherent at all times.

For example, on an enqueue operation, Block_{A} might read its own copy of the queue information, such as the head index, tail index and queue size, and determine whether the operation can complete. In addition, Block_{A} might also ensure that the appropriate information and resources (perhaps that the queue state is already read into a queue state cache) are available so that Block_{B} can complete its operation without performing any additional checks or work. If the operation can complete, Block_{A} updates its own state and passes the operation to Block_{B} for processing. The appropriate queue information (such as the tail index to be used as the offset to write the data) could also be passed from Block_{A} to Block_{B}. Block_{B} only needs to complete the operation and update its state.

A dequeue operation might be performed in a similar fashion. Block_{A} reads its own copy of the queue information and determines whether the operation can complete. If the operation can legally complete, Block_{A} updates its own state and passes the dequeue operation to Block_{B}. Block_{B} performs the dequeue operation, reading and returning the appropriate value, and updates its queue state.

Block_{A} can implement part of the enqueue operation and part of the dequeue operation, while Block_{B} can also implement part of the enqueue operation and part of the dequeue operation.

Another possibility is that only the enqueue operation needs to be sped up. In that case, Block_{A} may only have a count of the number of enqueue operations that can be legally completed. Then, as enqueues arrive, Block_{A} uses the count to determine if the enqueue can complete, and decrements the count to ensure his information is up-to-date. As dequeues arrive, the count is checked and incremented. Assuming a circular buffer to store the data, the count can also be used as an index into the circular buffer.

By splitting the queuing operations into two logical blocks, each logical block has less work to do and thus potentially has more time and resources to perform other tasks. For example, RED might be necessary between reading the queue state and the actual enqueue. Splitting the queuing operation between two logical blocks may reduce the work one of the logical blocks needs sufficiently to allow it to perform the RED operation.

This invention is not limited to splitting the queuing operations into only two logical blocks. In some cases, queuing operations can be split across more than two logical blocks. For example, one logical block may perform the queue fetch into the queue state cache, the next stage may perform the correctness and any other checks, such as RED, that need to be performed, and the following stage performs the actual enqueue.

An example of this invention within a network processor is shown in FIG. 5. The queuing operations take four micro-engines: one 44 to determine if the queue state is in the queue cache, fetch the queue state into the queue cache if it is not, and perform correctness and RED functions. Once the enqueue has been allowed, it is passed to the enqueue micro-engine 46 that actually performs the enqueue. The next stage 48 decides which queue gets serviced and ensures that the appropriate queue state is available in the hardware queue engine cache before passing a trigger to the following stage 50 that actually performs the dequeue operation.

Such a structure to implement split queuing functionality is mappable to the Intel IXP2400 and IXP2800 network processors. Those network processors provide hardware-assisted queue engines that support a limited number of queues. When using those queue engines with a larger number of queues, the software must maintain knowledge of which queues reside in which queue resources. In addition, the software must use the interfaces provided by the queue engines that separate the correctness check from the actual operation. In such systems or similar systems it may be impossible or inconvenient to check and enqueue/dequeue in the same operation; two operations in accordance with the present invention enable the full queuing process.

In addition, other work such as determining Quality of Service (QoS) operations, may need to take place between the queue state check operation (using a “check” operation to the queuing engine) and the actual enqueue/dequeue operation. Such operations, for example, may block the enqueue operation, even though there is sufficient space in the queue for the value being enqueued, due to some condition such as that queue using too much bandwidth recently. Such work can potentially be so expensive that it and the entire queuing operation cannot be completed by a single logical block while maintaining full performance, thus making a splitting of the queuing functionality necessary.

It is also possible that some sub-operations of queuing are better implemented in different logical blocks. For example, one logical block may have easy access to a larger amount of local state but does not have fast access to the queuing engine. In such cases, the appropriate partitioning of functionality may improve performance on some metric.

Thus, implementing one part of a queuing operation in one logical block and another part of the queuing operation in another logical block (and potentially further splitting the queuing operation across more logical blocks) reduces the amount of work per block and thus potentially enables the functionality and/or enables higher performance and/or makes better use of resources by implementing the specific sub-operation in a more resource-logical place.

This invention is useful in a variety of devices from pure hardware implementations such as in an ASIC or FPGA, network processors, simultaneous multi-threaded (SMT) processors and chip-based multi-processors (CMP). Logical blocks are essentially separate threads of control that can be mapped to different hardware engines, micro-engines, threads or processors.

While this invention has been particularly shown and described with references to preferred embodiments thereof, it will be understood by those skilled in the art that various changes in form and details may be made therein without departing from the scope of the invention encompassed by the appended claims.

1. A method of queuing comprising:
in a first logical block, performing a portion of a queuing operation; and
in a second logical block, performing another portion of the queuing operation.

2. A method as claimed in claim 1 wherein head and tail pointers are processed in each of the logical blocks.

3. A method as claimed in claim 1 wherein the first and second logical blocks are processed in separate processing hardware.

4. A method as claimed in claim 1 wherein the portion of the first logical block passes information to the portion of the second logical block.

5. A method as claimed in claim 4 wherein the information is a pointer to where in memory a value is to be written or read.

6. A method as claimed in claim 4 wherein the information is a number of remaining entries within the queue.

7. A method as claimed in claim 1 wherein an enqueuing completion operation is performed in the second logical block and a dequeuing completion operation is performed in a following logical block.

8. A method as claimed in claim 1 performed in a network processor.

9. A method as claimed in claim 8 wherein the first and second logical blocks are processed in separate processing hardware.

10. A method as claimed in claim 1 wherein a preparatory operation is performed in the first logical block and completion of the queuing operation is performed in the second logical block.

11. A method as claimed in claim 10 wherein plural preparatory operations are performed in plural logical blocks.

12. A method as claimed in claim 1 wherein an operation of fetching queue status is performed in the first logical block.

13. A method as claimed in claim 1 wherein an operation of correctness check is performed in the first logical block.

14. A method as claimed in claim 1 wherein a random early drop operation is performed in the first logical block.
